(19) United States
(12) Patent Application Publication
(10) Pub. No.: US 2026/0235200 A1
(43) Pub. Date: Aug. 13, 2026

(54) METHOD AND APPARATUS FOR FLUSHING CONTAMINANTS FROM A CONTAINER OF FLUIDS

(71) Applicant: Dennis B. Hansen, New Hampton, IA (US)

(72) Inventor: Dennis B. Hansen, New Hampton, IA (US)

(21) Appl. No.: 19/633,557

(22) Filed: Mar. 30, 2026

Related U.S. Application Data
(63) Continuation of application No. 19/050,870, filed on Feb. 11, 2025, now Pat. No. 12,590,630.
Application No. 19/050,870 is a continuation of application No. 18/228,442, filed on Jul. 31, 2023, now Pat. No. 12,305,746.
Application No. 18/228,442 is a continuation-in-part of application No. 17/120,527, filed on Dec. 14, 2020, now abandoned.
(60) Provisional application No. 62/947,897, filed on Dec. 13, 2019.
(60) Provisional application No. 63/014,972, filed on Apr. 24, 2020.
(60) Provisional application No. 63/418,776, filed on Oct. 24, 2022.

(51) Int. Cl. F16H 57/04; B08B 9/08; B08B 13/00; F01M 11/04

(52) U.S. Cl. CPC F16H 57/0408; B08B 9/08; B08B 13/00; F16H 57/0402; B08B 2209/08; F01M 11/0458

(57) ABSTRACT

A contaminant-flushing machine for removing contaminants from a container, such as an engine transmission, air-conditioner coil, or transmission cooler, which includes hoses for coupling to the transmission cooler and a pump for circulating fluid through the hoses and the transmission cooler, the flushing machine being configured to terminate all circulating of fluid when a pressure drop is detected during times when the fluid is circulating only in the primary flow direction, but not when the flow direction is being reversed.

### CROSS-REFERENCE TO RELATED APPLICATIONS

The present application is a continuation of U.S. Non-Provisional application Ser. No. 19/050,870, filed Feb. 11, 2025, which application is currently pending. U.S. Non-Provisional application Ser. No. 19/050,870 is a continuation of U.S. Non-Provisional application Ser. No. 18/228,442, filed Jul. 31, 2023, which application issued as U.S. Pat. No. 12,305,746 on May 20, 2025.

U.S. Non-Provisional application Ser. No. 18/228,442 is a continuation-in-part of U.S. Non-Provisional application Ser. No. 17/120,527, filed Dec. 14, 2020, entitled “Method and Apparatus for Flushing Contaminants from a Container of Fluids,” by the same inventor.

U.S. Non-Provisional application Ser. No. 17/120,527 claims the benefit of U.S. Provisional Application No. 62/947,897, entitled “AVIATION HOT FLUSH,” filed Dec. 13, 2019, and U.S. Provisional Application No. 63/014,972, entitled “AVIATION HOT FLUSH,” filed Apr. 24, 2020, both by Dennis B. Hansen.

The present application also claims the benefit of U.S. Provisional Application No. 63/418,776, filed Oct. 24, 2022, by the same inventor.

The present application claims the benefit of all of the above-referenced patent applications, and each of the above-mentioned patent applications is incorporated by reference herein in their entireties.

### BACKGROUND OF THE INVENTION

The present invention generally relates to fluid filtering, and more particularly relates to a method and apparatus for removing contaminants from a container having petroleum-based fluids therein, through a process of circulating, heating and filtering such fluids outside of the container.

In the past, automotive engineers and technicians have been among the many people to recognize the need for an ability to flush contaminants from fluid-containing enclosures or systems. One example of such a fluid-containing system is a transmission/transmission cooler system in which transmission fluid therein is normally cooled during operation of a vehicle by passing the transmission fluid through the transmission cooler. Such systems frequently contain tiny metal shavings resulting from wear of internal parts. It is desirable to provide an effective way to remove such metal shavings and other contaminants from the system without the need for completely dismantling the transmission and cooling system.

Systems for extracting transmission fluid from the system, then heating it and circulating this fluid through an external filter to thereby flush out contaminants from the transmission and cooling system, have enjoyed considerable success in the past. U.S. Pat. No. 7,510,662 issued to Dennis Hansen, provides much information regarding these systems. These systems have been commercially available to be purchased from Hot Flush Inc. of New Hampton, IA, which can be found at www.hotflusher.com. Hot Flush Inc. has sold two oil cooler flushers having Model numbers HF345S4 and HF345S9. These cooler flushers are well known in the art. These systems include therein a reverser valve for quickly reversing and then re-reversing, the flow through the cooler while it is being flushed. Normally, there are two hoses from the flusher to the cooler to be flushed, one which is the return from the cooler to the flusher and the other is the hose which normally provides heated oil into the cooler to be flushed.

These cooler flushers, in the early years, were used largely for the automotive industry. More recently, their use has expanded to include many different industries including aviation, military, construction equipment, agriculture, etc. The temperature of the cleaning fluid, its pressure and its flow rate depend upon the industry being serviced. For example, in the aviation industry, the cost of the equipment being serviced can often be in tens of millions of dollars. With higher pressures, higher temperatures, and higher flow rates, around high-cost equipment being serviced it is increasingly important to limit the impact of potential mishaps occurring with respect to the hot flusher machines.

Consequently, there exists a need for improved methods and apparatuses for flushing contaminants from a fluid container.

### SUMMARY OF THE INVENTION

It is an object of the present invention to provide an enhanced ability to reduce the adverse effects of a mishap involving a hot flusher machine.

It is a feature of the present invention to rapidly reduce a rate of leakage, or unwanted discharge, of cleaning fluid.

It is an advantage of the present invention to reduce the risk of injury to personnel and equipment that might be impacted by a sudden release of fluid from the hot flusher machine.

The present invention is an improved method and apparatus for removing contaminants from a container having fluids and contaminants therein, designed to satisfy the aforementioned needs, provide the previously stated objects, include the above-listed features, and achieve the already articulated advantages. The present invention is carried out in an “excessive rapid leakage-less” system in the sense that a substantial reduction in time required to stop a sudden unintended discharge of cleaning fluid is achieved. The present invention is further carried out in a “wasted automatic transmission fluid (ATF)-less” manner in the sense that a substantial reduction in ATF lost during a sudden leakage event is achieved with the present invention.

Accordingly, the present invention is a method and apparatus for detecting a sudden excessive leakage event and rapidly limiting effects of the event.

### BRIEF DESCRIPTION OF THE DRAWINGS

The invention may be more fully understood by reading the following description of preferred embodiments of the invention, in conjunction with the appended drawings wherein:

FIG. 1 is a simplified diagram showing contaminant-flushing machine of the present invention. The arrows show direction of flow of cleaning fluid through the hoses 301 and 302.

FIG. 2A and FIG. 2B are a schematic diagram of a control system for operation of the method and apparatus of the present invention.

### DETAILED DESCRIPTION

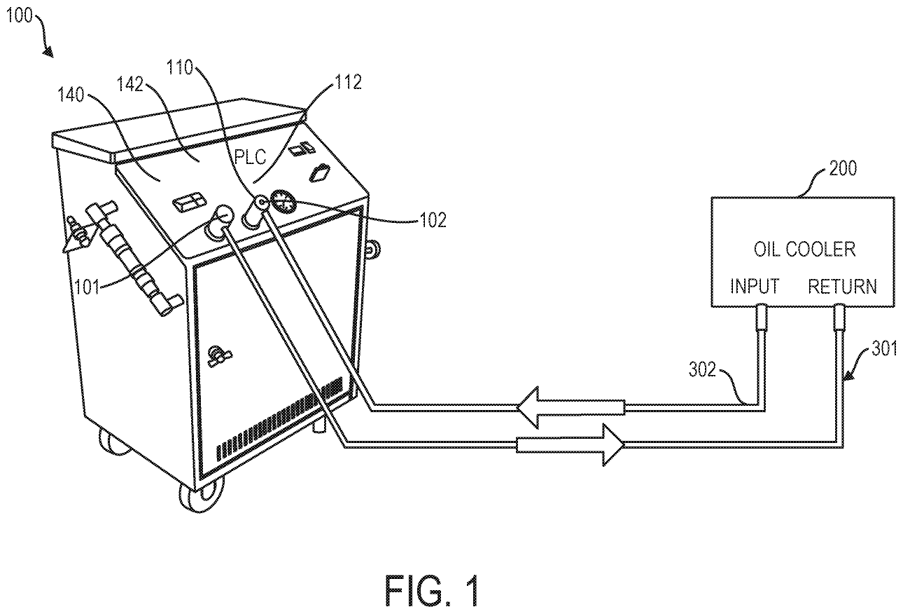

Now referring to FIG. 1, there is shown a simplified diagram of an improved contaminant-flushing machine, of the present invention, generally designated 100, which is coupled to an automobile transmission cooler 200 by connecting hoses 301 and 302. In normal operation, the flushing machine 100 back flushes the oil cooler in the sense that heated cleaning fluid is provided on hose 301 from the flusher machine 100 to the oil cooler connection which would normally return the oil to the transmission etc. from the cooler after it has been cooled in normal operation of the vehicle. This is labeled in FIG. 1 as RETURN in the oil cooler 200. I.e. the flusher machine is pumping heated fluid backward through the oil cooler 200 from the RETURN connection through the cooler and out the INPUT connection, where it flows back to the flusher machine 100 where hose 302 couples to connector 102. In some embodiments of the present invention, the connection between hose 302 and the flusher machine 100 could be identical to prior art flusher machines made for years by HotFlush Inc. However, in FIG. 1, connector 102 is shown as a special connector which has built therein a pressure sensor or pressure switch which detects the level of pressure in hose 302 and emits a signal on line 112 to programmable logic controller (PLC) 110. Also shown is multi-sensor and communication module 140 which is coupled to PLC via communication path 142. Module 140 can include fire and smoke detector and accelerometers for detecting motion. Module 140 may also include wireless communication equipment for WIFI or mobile phone connections for reporting events and conditions of the flushing machine 100 to remote locations. While connector 102 is shown as being a pressure sensor coupled to PLC 110, it should be understood that the pressure sensor for detecting the pressure in the line 302 could be located anywhere between the oil cooler 200 and the reverser, which is a standard portion of prior at Hot Flush Inc. flushing machines. In one embodiment, the pressure sensor of connector 102 could be moved to an inline connector just before connection to the reverser. Module 140 could also be configured to emit an audible alarm when commanded.

The general concept of the present invention is that once the flusher machine 100 is started and running, and between normal short duration reversal cycles, and if the PLC 110 would detect a drop in pressure from sensor 102, or a substitute sensor located elsewhere along line 302, PLC could command the heater and pump of the flusher machine 100 to stop. This could be accomplished by shutting down electric power at a circuit breaker on the flusher machine 100. In one embodiment, there could be delays created in commanding a low-pressure shutdown when the flushing machine is first started, for example, for 3-10 seconds, and during the very short duration flow reversals which are part of the normal operation of the flusher machine 100. The PLC could be programmed to ignore drops in pressure which occur during the times that a reversal is commanded or if they are shorter than a predetermined time period, which is longer than the normal time for reversal of the flow during reversal cycles. Alternatively, the sensor 102 or its substitute could be programmed to not provide a signal during times when a reversal is commanded or unless the duration of the low-pressure situation is longer than the predetermined duration of the normal reversal cycles.

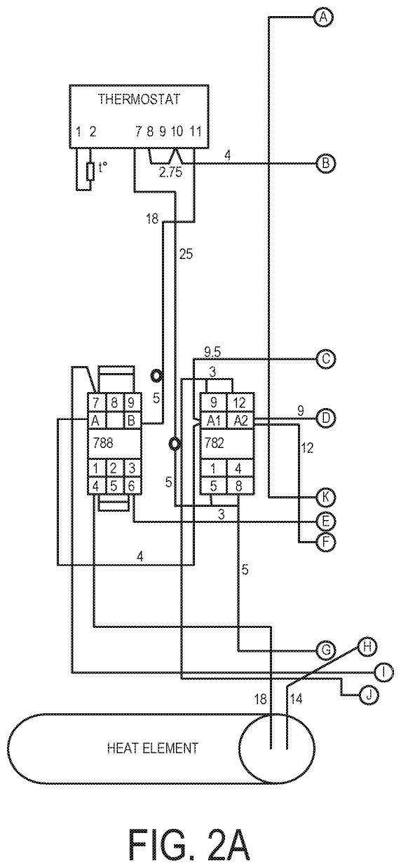

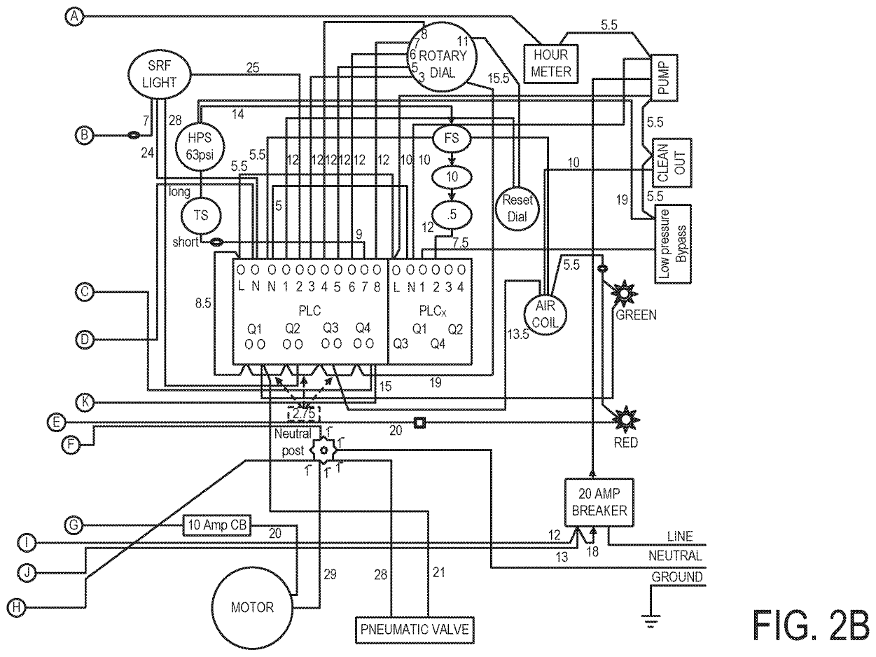

Now referring to FIGS. 2A and 2B, there is shown a schematic diagram of a control circuit of the present invention which provides electronic details of the system and method of the present invention.

Throughout this disclosure and description, the Applicant refers to a transmission cooler, oil coolers, transmission fluid, oil and other examples. These references are merely exemplary of the many different types of fluid containers and fluid types which could be utilized in conjunction with the present invention. For example, the present invention is intended to include and address systems for cleaning engine oil from an internal combustion engine, hydraulic oil from a hydraulic system, as well as fluid used in air-conditioning equipment. Various other systems, fluids and containers are contemplated and could be readily substituted, still within the spirit and scope of the present invention. The present invention can be used for oil cooler and oil lines in aircraft, jet engines, bulldozers, windmill electric generators and numerous other systems and fluid containers.

It is thought that the method and apparatus of the present invention will be understood from the foregoing description, and it will be apparent that various changes may be made in the form, construction, steps and arrangement of the parts and steps thereof without departing from the spirit and scope of the invention or sacrificing all of the material advantages, the form herein described being merely a preferred or exemplary embodiment thereof.

I claim:

1. A contaminant-flushing apparatus comprising: a pump configured to circulate a first fluid through a container; a reverser configured to temporarily reverse a flow direction of said first fluid through said container and to resume flow in a primary flow direction within a predetermined reversal interval; a sensor configured to monitor a characteristic of said first fluid and emit a signal; and a programmable logic controller (PLC) operatively coupled to said pump and said sensor, said PLC configured to command cessation of pumping of said first fluid in any direction upon receiving a signal from said sensor, except during said predetermined reversal interval.

2. The apparatus of claim 1, wherein said predetermined reversal interval is less than ten (10) seconds.

3. The apparatus of claim 1, wherein said predetermined reversal interval is less than one (1) second.

4. The apparatus of claim 1, wherein said reverser is a compressed-fluid-driven valve.

5. The apparatus of claim 1, wherein said sensor is a pressure sensor configured to detect a pressure drop in said first fluid.

6. The apparatus of claim 1, further comprising a multi-sensor module coupled to said PLC, said multi-sensor module comprising at least one of a fire detector, a smoke detector, and an accelerometer.

7. The apparatus of claim 6, wherein said multi-sensor module further comprises a wireless communication device configured to transmit operational status data to a remote location.

8. The apparatus of claim 1, wherein said PLC is further configured to command cessation of pumping upon receiving a signal from a fire or smoke detector during times other than during said predetermined reversal interval.

9. A fluid-flushing system for removing contaminants from a heat exchanger in a machine, the system comprising: a circulation pump; a fluid filter coupled in fluid communication with said circulation pump; a flow reverser configured to reverse and re-reverse a flow direction of a fluid through said heat exchanger within a reversal interval of less than ten (10) seconds; a pressure sensor disposed in a fluid line between said heat exchanger and said flow reverser; and a controller configured to halt operation of said circulation pump when said pressure sensor detects an anomalous pressure condition outside of said reversal interval, and configured to ignore pressure conditions detected during said reversal interval.

10. The system of claim 9, wherein said heat exchanger is a transmission fluid cooler configured to cool transmission fluid for a vehicle.

11. The system of claim 9, wherein said heat exchanger is an oil cooler disposed on an aircraft and configured to cool oil circulated through a jet engine.

12. The system of claim 9, wherein said heat exchanger is associated with a windmill electric generator.

13. A method of controlling a fluid-flushing apparatus, said method comprising: pumping a first fluid through a container in a primary flow direction;
periodically reversing a flow of said first fluid through said container for a reversal interval; monitoring a characteristic of said first fluid with a sensor; selectively commanding cessation of pumping based on signals received from said sensor; and
wherein said cessation is commanded only when said signal is received outside of said reversal interval, and cessation is not commanded based on signals received during said reversal interval.

14. The method of claim 13, wherein said reversal interval is less than ten (10) seconds.

15. The method of claim 13, wherein said reversal interval is less than one (1) second, and wherein said step of reversing a flow is accomplished with a compressed fluid.

16. The method of claim 13, further comprising: detecting at least one of a fire condition and a smoke condition with a sensor; and commanding cessation of pumping upon detecting said fire condition or smoke condition during times other than during said reversal interval.

17. A control system for a fluid circulation apparatus, comprising: a sensor configured to detect a characteristic of a fluid being circulated through a container by a pump; a programmable logic controller (PLC) communicatively coupled to said sensor and to said pump; and wherein said PLC is programmed to: (i) monitor signals from said sensor during operation of said pump; (ii) command cessation of operation of said pump when a predetermined signal is received from said sensor; and (iii) suppress cessation commands generated in response to signals received from said sensor during a predetermined reversal interval in which a flow direction of said fluid is being reversed.

18. The control system of claim 17, wherein said sensor is a pressure switch configured to detect a drop in pressure in said fluid below a predetermined threshold.

19. The control system of claim 17, further comprising a multi-sensor module communicatively coupled to said PLC, said multi-sensor module configured to detect at least one of fire, smoke, and motion, and to transmit corresponding signals to said PLC.

20. The control system of claim 19, wherein said multi-sensor module comprises a wireless communication device configured to transmit status signals to a remote monitoring location.
